(19) United States
(12) Patent Application Publication
(10) Pub. No.: US 2025/0214663 A1
(43) Pub. Date: Jul. 3, 2025

(54) SYSTEM FOR ADJUSTING TANDEMS ON COMMERCIAL VEHICLES

(71) Applicant: Eduardo Hadley, Libertyville, IL (US)

(72) Inventor: Eduardo Hadley, Libertyville, IL (US)

(21) Appl. No.: 18/772,732

(22) Filed: Jul. 15, 2024

Related U.S. Application Data
(60) Provisional application No. 63/616,902, filed on Jan. 2, 2024.

(51) Int. Cl. B62D 63/06; B60B 35/00

(52) U.S. Cl. CPC B62D 63/061; B60B 35/004

(57) ABSTRACT

A system for adjusting tandems in tandem axle trailers from within a cabin of the trailer and without requiring an operator of the tandem axle trailers to leave the cabin to adjust the tandems. The system includes a tandem air valve installed within a cabin which on actuation operates a pneumatic unit for adjusting the tandems. The pneumatic unit can engage and disengage a kingpin for sliding the tandems.

### CROSS-REFERENCE TO RELATED APPLICATIONS

This application claims priority from a U.S. Provisional Patent Appl. No. 63/616,902, filed on Jan. 2, 2024, which is incorporated herein by reference in its entirety.

### FIELD OF INVENTION

The present invention relates to a system for sliding tandems on trucks and trailers, and more particularly, the present invention relates to a system for sliding tandem from within a cabin of the vehicle.

### BACKGROUND

Tandem axle trailers are designed to carry much heavier loads compared to single axle trailers. They are equipped with two sets of axles, which allows for a greater payload capacity. However, it's crucial to ensure that tandem axle trailers are towed in a level and balanced manner to prevent premature wear and tear on the axles and tires.

Level towing in tandem axle trailers is achieved by a mechanism known as sliding tandems, which involves the longitudinal displacement of the tandem axles. Usually, a trailer cannot be evenly loaded along its length. Tandems are adjusted during loading to evenly distribute the load on the axles and tires of the trailers. However, these adjustments must be made manually, which is a laborious process. The trailer operator has to leave the cabin multiple times to adjust the sliding tandems of the semi-truck, and this process may require a helper to assist the driver in sliding the tandem. Manually engaging and disengaging the locking pins can be laborious, and it can be frustrating when the locking pins are stuck. Overall, the manual process is strenuous, frustrating, and time-consuming.

Adjusting the tandems in a tandem axle trailer from within the cabin without external help or needing to leave the cabin is desired.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system for adjusting tandems in a trailer from within a cabin of the trailer.

It is another object of the present invention that the system allows adjusting the tandems easily and quickly.

Still, another object of the present invention is that the problem of stuck tandems can be avoided.

A further object of the present invention is that the additional need for a helper may not be needed.

In one aspect, disclosed is a system for adjusting sliding tandems in a vehicle, the system comprising a pneumatic unit which upon actuation is configured to engage and disengage a kingpin of the sliding tandems; and a tandem adjusting valve configured to be positioned within a cabin of the vehicle, wherein actuation of the tandem adjusting valve operates the pneumatic unit for engaging and disengaging the kingpin of the sliding tandems. The vehicle is a tandem axle trailer. The tandem adjusting valve is positioned on a dashboard of the vehicle. The tandem adjusting valve is further connected to an air tank containing air under pressure. The tandem adjusting valve is connected to the pneumatic unit through an air hose and a glad hand.

In one aspect, disclosed is a method for adjusting sliding tandems in a vehicle, the method comprises installing a tandem release valve in a cabin of the vehicle; connecting an air tank to the tandem release valve for supplying air under pressure; and connecting the tandem release valve to a pneumatic unit through a glad hand coupler and an air hose, wherein the pneumatic unit upon actuation is configured to engage and disengage a kingpin of the sliding tandems.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of an air tank of the system, according to an exemplary embodiment of the present invention.

FIG. 2 shows a gladhand for connecting the air hose, according to an exemplary embodiment of the present invention.

FIG. 3 shows a dashboard of a semi-truck having a tandem adjusting valve of the system, according to an exemplary embodiment of the present invention.

FIG. 4 is a block diagram showing the architecture of the system, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context indicates otherwise. It will be further understood that the terms “comprise”, “comprising”, “includes”, and “including” when used herein, specify the presence of stated features, integers, steps, operations, elements, and components, but do not preclude the presence or addition of one or more other features, integers, steps, operations, elements, components, and groups thereof.

The following detailed description includes the best currently contemplated mode or modes of carrying out exemplary embodiments of the invention. The description merely describes the generation principles of the invention and therefore should not be taken in a limiting sense. The allowed claims can best define the scope of this invention.

The described invention pertains to a system and method for adjusting tandems in trailers and the like vehicles. The disclosed system allows for adjusting the tandems from within the cabin of the vehicle. A person, who can be a driver of the vehicle, does not need to leave the cabin of the trailer to adjust the tandem. Thus, the process is made easy, and the tandems can be adjusted during weight adjustment, loading of the vehicle, and unloading of the vehicle. Also, the tandems can be adjusted by the person from within the cabin without external help.

The disclosed system includes a pneumatic unit that can operate tandems. The pneumatic unit upon actuation can engage and disengage the locking pin for adjusting the same. The structure and functioning of the locking pins for locking the sliding tandems in a trailer are well known.

The system further includes a tandem adjusting valve that can be positioned inside the cabin of the vehicle. The tandem adjusting valve can operate the pneumatic unit remotely i.e., from within the cabin. The pneumatic unit can be operated by air under pressure. An airline from an air tank can supply the air under pressure to the pneumatic unit. A trailer glad hand can provide the connectivity of a valve in the cabin to the airline for opening and closing the air supply to the pneumatic unit. The structure and functioning of the glad hand in trailers are well known, for example, are used in braking systems.

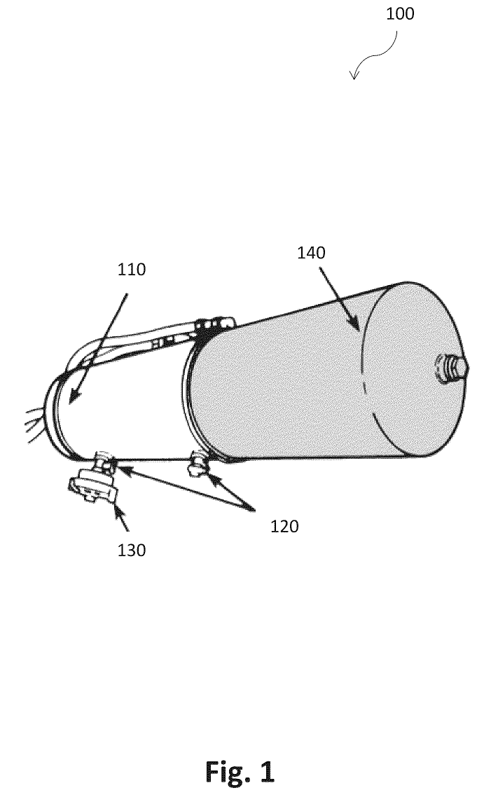

Referring to FIG. 1 shows an exemplary embodiment of an air tank 100 for supplying air under pressure for operating the pneumatic unit (not shown). The air under pressure is used to pneumatically operate the locking pin of the tandem. The air tank includes a supply reservoir 110, drain cocks 120, an automatic drain valve 130, and a secondary reservoir 140.

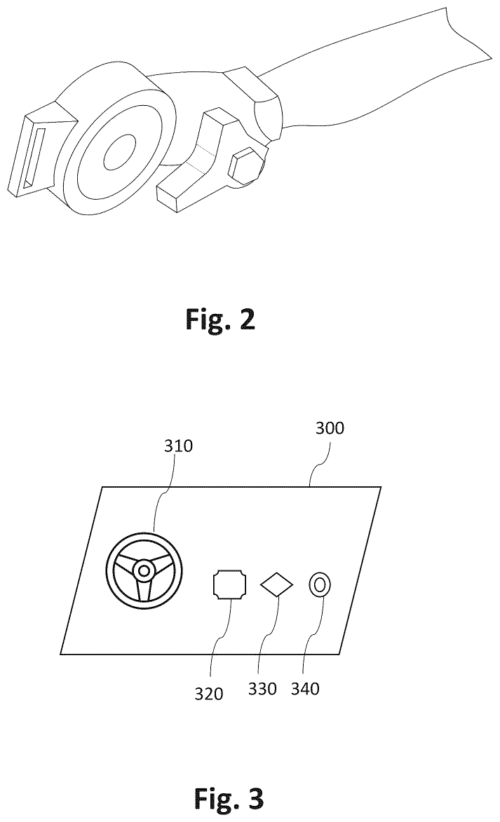

FIG. 2 shows a gladhand coupler 200 for connecting the tandem air hose of the system. The structure and functioning of gladhands in connecting airlines are well-known in the art. A gladhand connector, also known as a gladhand coupler, is an interlocking hose coupling fitted to hoses supplying pressurized air from the trailer to the air brakes. Such a gladhand coupler can be used in the disclosed system for connecting the air hoses.

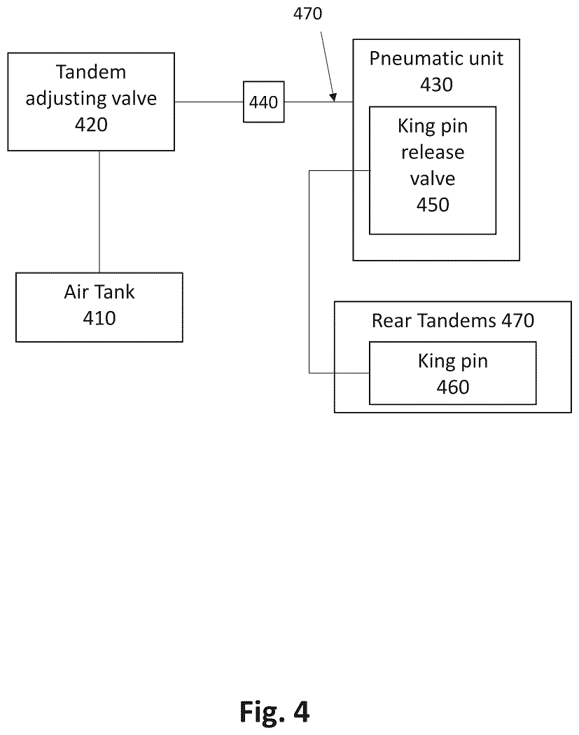

Referring to FIG. 3 which shows a dashboard 300 of a semi-truck. FIG. 3 shows a steering wheel 310, a trailer air supply valve 320, a parking brake valve, and a tandem adjustment valve 330. The functioning of the trailer air supply valve and the parking brake valve are well known. The tandem adjustment valve according to the present invention can supply and evacuate the air into and out, respectively, of a trailer kingpin while operating the pneumatic unit for tandem adjustments. It is to be noted that the position of the tandem adjustment valve in the cabin can be changed without departing from the scope of the present invention.

FIG. 3 shows an exemplary embodiment of a tandem adjusting valve 330 of the system. The tandem adjusting valve can be positioned within a cabin of the vehicle, such as an operator of the vehicle can operate the tandem adjusting valve from within the cabin. The actuation of the tandem adjusting valve from within the cabin results in the actuation of the pneumatic unit by opening the air supply lines from the air tank.

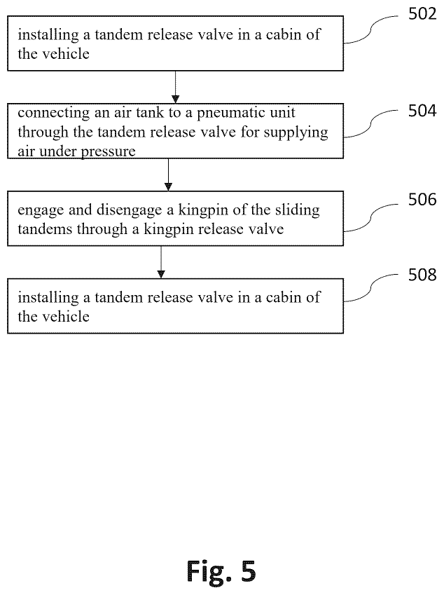

Referring to FIG. 4, which is a block diagram showing the architecture of the disclosed system. The system may include an air tank 410 for supplying air under pressure. The air tank 410 can be a separate air tank or an existing air tank in the semi-truck. Also, the semi-truck may include other components, such as a compressor for compressing the air. Such components are well known in art for use in trucks.

An air hose from the air tank can connect to the tandem adjusting valve 420 in the cabin of the semi-truck. The tandem adjusting valve 420 can control the air supply to the pneumatic unit 430. Another airline can connect the tandem release valve 420 to the pneumatic unit 430 through a glad hand coupler 440. The pneumatic unit 430 can contain a kingpin release valve 450 which can be actuated by air under pressure to engage and disengage the kingpin 460. The kingpin is also referred to herein as a locking pin.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

1. A system for adjusting sliding tandems in a vehicle from a cabin of the vehicle during weight adjustment, loading of the vehicle, and unloading of the vehicle, the system consisting of:
a pneumatic unit which upon actuation is configured to engage and disengage a kingpin of the sliding tandems through a kingpin release valve;
an airline connecting the pneumatic unit to an air tank containing air under pressure, the air tank comprising a secondary reservoir;
a tandem adjusting valve configured to be positioned within a cabin of the vehicle, wherein actuation of the tandem adjusting valve operates the pneumatic unit for engaging and disengaging the kingpin of the sliding tandems; and
a trailer glad hand connecting the tandem adjusting valve to the airline for opening and closing air supply to the pneumatic unit.

2. The system of claim 1, wherein the vehicle is a tandem axle trailer.

3. The system of claim 1, wherein the tandem adjusting valve is positioned on a dashboard of the vehicle.

4. (canceled)

5. (canceled)

6. A method for adjusting sliding tandems in a vehicle from a cabin of the vehicle during weight adjustment, loading of the vehicle, and unloading of the vehicle, the method comprises:
installing a tandem release valve in a cabin of the vehicle; and
connecting an air tank to a pneumatic unit through the tandem release valve for supplying air under pressure, wherein the pneumatic unit upon actuation is configured to engage and disengage a kingpin of the sliding tandems through a kingpin release valve;
wherein the tandem release valve is connected to the pneumatic unit through a glad hand coupler and an airline.
